(19) United States
(12) Patent Application Publication
(10) Pub. No.: US 2024/0178952 A1
(43) Pub. Date: May 30, 2024

(54) BLUETOOTH COMMUNICATION METHOD FOR SETTING BLUETOOTH FREQUENCY HOPPING CONFIGURATION IN HIGH BAND AND ASSOCIATED BLUETOOTH COMMUNICATION DEVICE

(71) Applicant: MEDIATEK INC., Hsin-Chu (TW)

(72) Inventors: Yen-Shuo Lu, Hsinchu City (TW); Ting-Che Tseng, Hsinchu-City (TW); Wen-Chieh Tsai, Hsinchu City (TW)

(73) Assignee: MEDIATEK INC., Hsin-Chu (TW)

(21) Appl. No.: 18/519,081

(22) Filed: Nov. 27, 2023

Related U.S. Application Data
(60) Provisional application No. 63/385,045, filed on Nov. 28, 2022.

(51) Int. Cl. H04L 5/00; H04W 8/00; H04W 76/28

(52) U.S. Cl. CPC H04L 5/0012; H04W 8/005; H04W 76/28

(57) ABSTRACT

A Bluetooth (BT) communication method includes: setting a BT frequency hopping configuration in a frequency band that is higher than a 2.4 GHz band; and performing a BT communication operation that is compliant with the BT frequency hopping configuration in the frequency band. In addition, the BT communication method is employed by a BT communication device having a control circuit and a wireless communication circuit.

### CROSS REFERENCE TO RELATED APPLICATIONS

This application claims the benefit of U.S. Provisional Application No. 63/385,045, filed on Nov. 28, 2022. The content of the application is incorporated herein by reference.

### BACKGROUND

The present invention relates to a frequency hopping technique, and more particularly, to a Bluetooth (BT) communication method for setting a BT frequency hopping configuration in a high band (e.g., a frequency band higher than a 2.4 Ghz band) and an associated BT communication device.

Interference is one of the biggest challenges for any wireless technology in providing reliable communications. Since different wireless technologies, including BT, Wi-Fi, Zigbee, etc., may share the same transmission medium, it is possible for a packet that is being transmitted to be corrupted or lost if it collides with another packet being transmitted at the exact same time and on the same frequency channel. One of the techniques that BT technology uses to mitigate interference and find a clear transmission path that avoids packet collision is frequency hopping. In accordance with frequency hopping, a BT system divides a frequency band (e.g., 2.4 GHz band) into smaller channels (e.g., 80 channels), and rapidly hops between those channels when transmitting packets.

The 2.4 GHz band is crowded due to the fact that a variety of systems use this frequency band. Thus, there is a need for an innovative BT frequency hopping design that leverages a high band with large frequency range and less interference for achieving a high data rate and a low re-transmission rate.

### SUMMARY

One of the objectives of the claimed invention is to provide a BT communication method for setting a BT frequency hopping configuration in a high band (e.g., a frequency band higher than a 2.4 GHz band) and an associated BT communication device.

According to a first aspect of the present invention, an exemplary BT communication method is disclosed. The exemplary BT communication method includes: setting a BT frequency hopping configuration in a frequency band that is higher than a 2.4 GHz band; and performing a BT communication operation that is compliant with the BT frequency hopping configuration in the frequency band.

According to a second aspect of the present invention, an exemplary BT communication device is disclosed. The exemplary BT communication device includes a control circuit and a wireless communication circuit. The control circuit is arranged to set a BT frequency hopping configuration in a frequency band that is higher than a 2.4 GHz band. The wireless communication circuit is arranged to perform a BT communication operation that is compliant with the BT frequency hopping configuration in the frequency band.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a BT communication device according to an embodiment of the present invention.

FIG. 2 is a diagram illustrating channel allocations of a 5 GHz band and a 6 GHz band that can be used by high-band BT communications.

FIG. 3 is a diagram illustrating a first case of setting the BT frequency hopping configuration in the high band according to an embodiment of the present invention.

FIG. 4 is a diagram illustrating a second case of setting the BT frequency hopping configuration in the high band according to an embodiment of the present invention.

FIG. 5 is a diagram illustrating a third case of setting the BT frequency hopping configuration in the high band according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

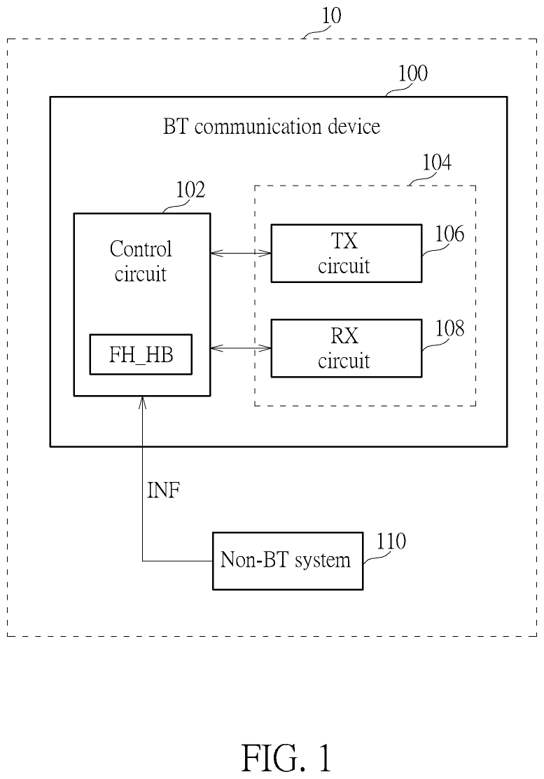

FIG. 1 is a diagram illustrating a BT communication device according to an embodiment of the present invention. The BT communication device 100 includes a control circuit 102 and a wireless communication circuit 104. The wireless communication circuit 104 acts as a wireless interface, and includes a transmit (TX) circuit 106 and a receive (RX) circuit 108. It should be noted that only the components pertinent to the present invention are illustrated in FIG. 1. In practice, the wireless communication circuit 104 can include additional components to achieve designated functions. The BT communication device 100 supports a frequency hopping (FH) function. By way of example, but not limitation, the TX circuit 106 may include a pseudo-random hopping sequence generator, a frequency generator, and a modulator, and the RX circuit may include a pseudo-random hopping sequence generator, a frequency generator, and a demodulator. For example, the modulator/demodulator may be implemented using a Gaussian frequency shift keying (GFSK) modulator/demodulator, a 8 phase shift keying (8PSK) modulator/demodulator, a 16 quadrature amplitude modulation (16QAM) modulator/demodulator, or any suitable modulator/demodulator.

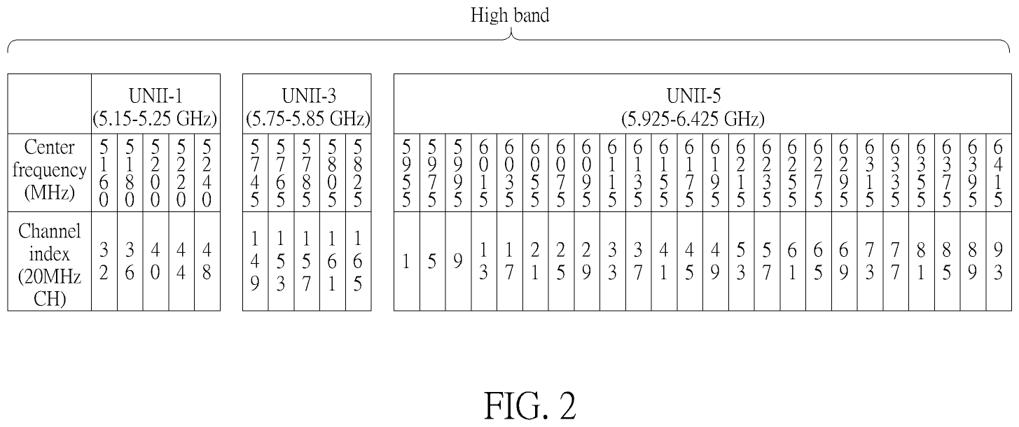

The control circuit 102 is arranged to set a BT frequency hopping configuration FH_HB in a high band (e.g., a frequency band that is higher than a 2.4 GHz band). For example, the high band may include one or both of a 5 GHz band and a 6 GHz band. The BT frequency hopping configuration FH_HB includes BT channels selected from the high band. For example, the BT channels specified in the BT frequency hopping configuration FH_HB may be selected from 20 MHz channels in UNII-1 (5.15-5.25 GHz), 20 MHz channels in UNII-3 (5.725-5.850 GHz), and 20 MHz channels in UNII-5 (5.925-6.425 GHz) shown in FIG. 2. The control circuit 102 may be implemented by a general-purpose processor for realizing the proposed function of setting the BT frequency hopping configuration FH_HB in a software-based manner, or may be implemented by a dedicated controller for realizing the proposed function of setting the BT frequency hopping configuration FH_HB in a hardware-based manner. To put it another way, the present invention has no limitations on the implementation of the control circuit 102. The wireless communication circuit 104 is arranged to perform a BT communication operation that is compliant with the BT frequency hopping configuration FH_HB in the high band. That is, the high-band (HB) BT frequency hopping behavior is constrained by the BT frequency hopping configuration FH_HB. Further details of the BT frequency hopping configuration FH_HB are described as below with reference to the accompanying drawings.

In some embodiments of the present invention, multiple wireless communication systems may coexist in an electronic device. As shown in FIG. 1, the BT communication device 100 (which is a part of a BT system) and a non-BT system 110 may coexist in a chip 10. For example, the non-BT system 110 may be a Wi-Fi system or a Zigbee system. However, this is for illustrative purposes only, and is not meant to be a limitation of the present invention. Any BT communication device that supports the proposed function of setting the BT frequency hopping configuration FH_HB in the high band falls within the scope of the present invention.

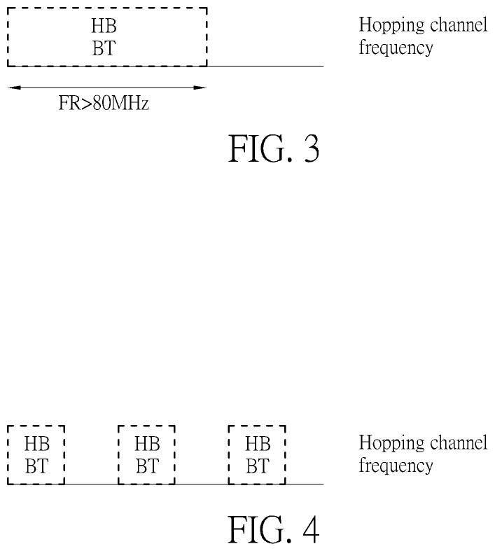

FIG. 3 is a diagram illustrating a first case of setting the BT frequency hopping configuration FH_HB in the high band according to an embodiment of the present invention. Typically, all BT channels of a same frequency hopping sequence specified in a BT frequency hopping configuration in the 2.4 GHz band are populated within a frequency range of 80 MHz. According to the first case, all BT channels of a same frequency hopping sequence specified in the BT frequency hopping configuration FH_HB in the high band (e.g., 5 GHz band and/or 6 GHz band) are populated within a frequency range FR that is larger than the frequency range of 80 MHz. For example, 80 channels involved in frequency hopping of the HB BT communication may be randomly distributed in 5.725-5.850 GHz (which is a frequency range of 125 MHz). For another example, the number of BT channels populated within the frequency range FR in the high band (e.g., 5 GHz band and/or 6 GHz band) for frequency hopping may be different from (e.g., larger than) the number of BT channels populated within the 80 MHz frequency range in the 2.4 GHz band for frequency hopping.

FIG. 4 is a diagram illustrating a second case of setting the BT frequency hopping configuration FH_HB in the high band according to an embodiment of the present invention. A same frequency hopping sequence specified in the BT frequency hopping configuration FH_HB in the high band (e.g., 5 GHz band and/or 6 GHz band) includes continuous BT channels with discontinuous center frequencies in the high band (e.g., 5 GHz band and/or 6 GHz band). That is, BT channels involved in frequency hopping of the HB BT communication may be defined by distributed frequency selection rather than continuous frequency selection. For example, four 20 MHz channels with channel indexes 9, 29, 45 and 61 in UNII-5 shown in FIG. 2 may be selected as BT channel involved in frequency hopping, and the rest of the 20 MHz channels in UNII-5 are not selected as BT channel involved in frequency hopping.

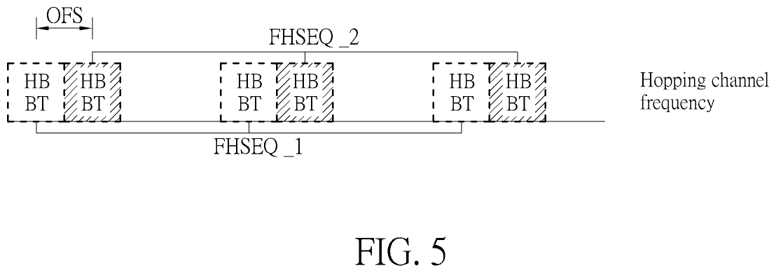

FIG. 5 is a diagram illustrating a third case of setting the BT frequency hopping configuration FH_HB in the high band according to an embodiment of the present invention. A first frequency hopping sequence FHSEQ_1 and a second frequency hopping sequence FHSEQ_2 are specified in the BT frequency hopping configuration FH_HB in the high band (e.g., 5 GHz band and/or 6 GHz band), and there is a constant frequency offset OFS (e.g., OFS=20 MHz) between the first frequency hopping sequence FHSEQ_1 and the second frequency hopping sequence FHSEQ_2. Suppose that each of the first frequency hopping sequence FHSEQ_1 and the second frequency hopping sequence FHSEQ_2 includes M channels in an ascending order of center frequencies, where the 1^{st} channel has a lowest center frequency, and the M^{th} channel has a highest center frequency. Hence, a center frequency of the i^{th} channel (1≤i≤M) included in the second frequency hopping sequence FHSEQ_2 is equal to a center frequency of the i^{th} channel (1≤i≤M) included in the first frequency hopping sequence FHSEQ_1 plus the constant frequency offset OFS (e.g., OFS=20 MHz). For example, the first frequency hopping sequence FHSEQ_1 may include 20 MHz channels with channel indexes 9, 25, 41, and 57 in UNII-5 shown in FIG. 2, and the second frequency hopping sequence FHSEQ_2 may include 20 MHz channels with channel indexes 13, 29, 45, and 61 in UNII-5 shown in FIG. 2.

In a fourth case of setting the BT frequency hopping configuration FH_HB in the high band according to an embodiment of the present invention, the control circuit 102 is further arranged to instruct the wireless communication circuit 104 to perform a BT channel scan upon a plurality of channels in the high band (e.g., 5 GHz band and/or 6 GHz band) to generate a scan result, where the plurality of channels include Wi-Fi preferred scanning channels (PSCs), and the BT frequency hopping configuration FH_HB is set by the control circuit 102 according to at least the scan result. For example, the non-BT system 110 is a Wi-Fi system, and the BT channel scan may only scan Wi-Fi PSCs that are 20 MHz channels with indexes 5, 21, 37, 53, 69, and 85 in UNII-5 shown in FIG. 2.

In a fifth case of setting the BT frequency hopping configuration FH_HB in the high band according to an embodiment of the present invention, any BT channel specified in the BT frequency hopping configuration FH_HB in the high band (e.g., 5 GHz band and/or 6 GHz band) does not overlap any channel that is used by the non-BT system 110 in the high band (e.g., 5 GHz band and/or 6 GHz band) and has a channel width not smaller than a predetermined value. For example, the non-BT system 110 is a Wi-Fi system, and the predetermined value is 80 MHz. Hence, according to the setting of the BT frequency hopping configuration FH_HB, BT frequency hopping only applies to BT channels that are non-BW80 Wi-Fi channels in UNII-1, UNII-3, and UNII-5. In this way, the HB BT communication rapidly hops on 5150-5170 MHz in UNII-1, 5725-5735 MHz and 5815-5850 MHz in UNII-3, and/or 5925-5945 MHz in UNII-5.

In a sixth case of setting the BT frequency hopping configuration FH_HB in the high band according to an embodiment of the present invention, the BT communication device 100 is a part of a BT system, the BT system and the non-BT system 110 coexist in the same chip 10 (which may be used by an electronic device such as a cellular phone), and the BT frequency hopping configuration FH_HB in the high band (e.g., 5 GHz band and/or 6 GHz band) does not include a channel of the high band (e.g., 5 GHz band and/or 6 GHz band) that is used by the non-BT system 110. For example, the non-BT system may be a Wi-Fi system or a Zigbee system. Specifically, the non-BT system 110 may provide link information INF to the BT system (particularly, control circuit 102 of BT communication device 100), such that the BT system does not use a BT channel that is located at a center frequency of a link used by the non-BT system 110.

In summary, the first case and the second case can lower the chance that the HB BT communication has collisions with the non-BT communication; the third case can have easy control for different BT links to avoid collisions; the fourth case can save the BT channel scan time and keep the high detection rate of Wi-Fi interference; the fifth case can avoid Wi-Fi co-channel interference (CCI); and the sixth case can have better co-existence performance due to no in-chip Wi-Fi CCI.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A Bluetooth (BT) communication method comprising:
setting a BT frequency hopping configuration in a frequency band that is higher than a 2.4 GHz band; and
performing a BT communication operation that is compliant with the BT frequency hopping configuration in the frequency band.

2. The BT communication method of claim 1, wherein all BT channels of a same frequency hopping sequence specified in a BT frequency hopping configuration in the 2.4 GHz band are populated within a first frequency range, and all BT channels of a same frequency hopping sequence specified in the BT frequency hopping configuration in the frequency band are populated within a second frequency range that is larger than the first frequency range.

3. The BT communication method of claim 2, wherein a number of BT channels populated within the second frequency range in the frequency band for frequency hopping is larger than a number of BT channels populated within the first frequency range in the 2.4 GHz band for frequency hopping.

4. The BT communication method of claim 1, wherein a same frequency hopping sequence specified in the BT frequency hopping configuration in the frequency band comprises continuous BT channels with discontinuous center frequencies in the frequency band.

5. The BT communication method of claim 1, wherein a first frequency hopping sequence and a second frequency hopping sequence are specified in the BT frequency hopping configuration in the frequency band, and there is a constant frequency offset between the first frequency hopping sequence and the second frequency hopping sequence.

6. The BT communication method of claim 1, further comprising:
performing a BT channel scan upon a plurality of channels in the frequency band to generate a scan result, wherein the plurality of channels comprise Wi-Fi preferred scanning channels (PSCs);
wherein setting the BT frequency hopping configuration in the frequency band comprises:
setting the BT frequency hopping configuration in the frequency band according to at least the scan result.

7. The BT communication method of claim 1, wherein any BT channel specified in the BT frequency hopping configuration in the frequency band does not overlap any channel that is used by a non-BT system in the frequency band and has a channel width not smaller than a predetermined value.

8. The BT communication method of claim 7, wherein the non-BT system is a Wi-Fi system, and the predetermined value is 80 MHz.

9. The BT communication method of claim 1, wherein the BT communication method is employed by a BT system, the BT system and a non-BT system coexist in a same chip, and the BT frequency hopping configuration in the frequency band does not include a channel of the frequency band that is used by the non-BT system.

10. The BT communication method of claim 9, wherein the non-BT system is a Wi-Fi system or a Zigbee system.

11. The BT communication method of claim 1, wherein the frequency band comprises at least one of a 5 GHz band and a 6 GHz band.

12. A Bluetooth (BT) communication device comprising:
a control circuit, arranged to set a BT frequency hopping configuration in a frequency band that is higher than a 2.4 GHz band; and
a wireless communication circuit, arranged to perform a BT communication operation that is compliant with the BT frequency hopping configuration in the frequency band.

13. The BT communication device of claim 12, wherein the control circuit is further arranged to set a BT frequency hopping configuration in the 2.4 GHz band, all BT channels of a same frequency hopping sequence specified in the BT frequency hopping configuration in the 2.4 GHz band are populated within a first frequency range, and all BT channels of a same frequency hopping sequence specified in the BT frequency hopping configuration in the frequency band are populated within a second frequency range that is larger than the first frequency range.

14. The BT communication device of claim 13, wherein a number of BT channels populated within the second frequency range in the frequency band for frequency hopping is larger than a number of BT channels populated within the first frequency range in the 2.4 GHz band for frequency hopping.

15. The BT communication device of claim 12, wherein a same frequency hopping sequence specified in the BT frequency hopping configuration in the frequency band comprises continuous BT channels with discontinuous center frequencies in the frequency band.

16. The BT communication device of claim 12, wherein a first frequency hopping sequence and a second frequency hopping sequence are specified in the BT frequency hopping configuration in the frequency band, and there is a constant frequency offset between the first frequency hopping sequence and the second frequency hopping sequence.

17. The BT communication device of claim 12, wherein the control circuit is further arranged to instruct the wireless communication circuit to perform a BT channel scan upon a plurality of channels in the frequency band to generate a scan result, where the plurality of channels comprise Wi-Fi preferred scanning channels (PSCs), and the BT frequency hopping configuration in the frequency band is set by the control circuit according to at least the scan result.

18. The BT communication device of claim 12, wherein any BT channel specified in the BT frequency hopping configuration in the frequency band does not overlap any channel that is used by a non-BT system in the frequency band and has a channel width not smaller than a predetermined value.

19. The BT communication device of claim 18, wherein the non-BT system is a Wi-Fi system, and the predetermined value is 80 MHz.

20. The BT communication device of claim 12, wherein the BT communication device is a part of a BT system, the BT system and a non-BT system coexist in a same chip, and the BT frequency hopping configuration in the frequency band does not include a channel of the frequency band that is used by the non-BT system.

21. The BT communication device of claim 20, wherein the non-BT system is a Wi-Fi system or a Zigbee system.

22. The BT communication device of claim 12, wherein the frequency band comprises at least one of a 5 GHz band and a 6 GHz band.
